(19) United States
(12) Patent Application Publication
(10) Pub. No.: US 2018/0300258 A1
(43) Pub. Date: Oct. 18, 2018

(54) ACCESS RANK AWARE CACHE REPLACEMENT POLICY

(71) Applicant: Futurewei Technologies, Inc., Plano, TX (US)

(72) Inventors: Sushma Wokhlu, Frisco, TX (US); Alex Elisa Chandra, Plano, TX (US); Alan Gatherer, Richardson, TX (US)

(73) Assignee: Futurewei Technologies, Inc., Plano, TX (US)

(21) Appl. No.: 15/486,699

(22) Filed: Apr. 13, 2017

(51) Int. Cl. G06F 12/126

(52) U.S. Cl. CPC G06F 12/126; G06F 2212/69; G06F 2212/1044

(57) ABSTRACT

A method of operating a cache memory comprises receiving a first read or write command including at least a first address referring to first data and a first rank indicator associated with the first data, and in response to receiving the first read or write command, reading or writing the first data referenced by the first address, and storing the first rank indicator.

### BACKGROUND

In many systems, a processor communicates with a main memory. Communication between a processor and main memory can be a limiting factor in overall system performance. One or more cache memories, which are faster than main memory, may be used to provide a processor with fast access to cached data and/or allow a processor to send data faster than it can be written in main memory, and may thus improve system performance. However, cache memory is generally expensive so the size of cache memory may be limited by cost. Efficient use of the limited space available in cache memory is generally desirable. Various cache policies are used to attempt to retain the most frequently accessed data in cache while leaving less frequently accessed data in main memory only. Examples of cache replacement policies include least recently used (LRU), which evicts the least recently used (accessed) data from cache, and most recently used (MRU), which evicts the most recently used data from cache.

### SUMMARY

According to one aspect of the present disclosure, there is provided a method of operating a cache memory, that includes: receiving a first read or write command including at least a first address referring to first data and a first rank indicator associated with the first data; and in response to receiving the first read or write command, reading or writing the first data referenced by the first address, and storing the first rank indicator.

Optionally, in any of the preceding aspects the method further includes caching the first data in the cache memory; and determining whether to retain the first data in the cache memory according to the first rank indicator.

Optionally, in any of the preceding aspects the method further includes: the first rank indicator is a do-not-cache indicator and, in response to receiving the first read or write command, reading or writing the first data referenced by the first address without caching the first data in the cache memory.

Optionally, in any of the preceding aspects the method further includes: receiving a second read or write command including at least a second address and a second rank indicator associated with the second address; in response to receiving the second read or write command, reading or writing second data referenced by the second address, caching the second data in the cache memory, and storing the second rank indicator; and determining whether to retain the first or second data in the cache memory by comparing the first rank indicator and the second rank indicator.

Optionally, in any of the preceding aspects the method further includes: the first rank indicator is at least one of a read rank indicator, a write rank indicator, a keep indicator, a valid indicator, a do-not-cache indicator, or a cache-if-free indicator.

Optionally, in any of the preceding aspects the method further includes: the first rank indicator is a multi-bit value that is sent with a corresponding read or write command.

Optionally, in any of the preceding aspects the method further includes: receiving an updated rank indicator associated with the first address, the updated rank indicator being different from the first rank indicator; replacing the first rank indicator with the updated rank indicator; and determining whether to retain the first data in the cache memory according to the updated rank indicator.

Optionally, in any of the preceding aspects the method further includes: retaining a list of rank indicators for data that was evicted from the cache memory; and identifying evicted data to be prefetched into the cache memory according to rank indicators in the list of rank indicators.

Optionally, in any of the preceding aspects the method further includes: prefetching evicted data with rank indicators higher than a threshold into the cache memory.

Optionally, in any of the preceding aspects the method further includes: comparing rank indicators of evicted data; and prefetching data into the cache memory in descending order from higher rank to lower rank.

According to one aspect of the present disclosure, there is provided a system that includes: a cache memory, wherein the cache memory comprises: a master interface to receive a command and a rank indicator; a cache tag to store the rank indicator, wherein the rank indicator in the cache tag referring to data accessed by the command and indicating read or write rank of the data; and a memory interface to read or write data to a memory of the system.

Optionally, in any of the preceding aspects the system further includes: the rank indicator comprises at least one of a read rank indicator, a write rank indicator, a keep indicator, a valid indicator, a do-not-cache indication, or a cache-if-free indicator.

Optionally, in any of the preceding aspects the system further includes: a cache controller to evict data from the cache memory according to the rank indicator in the cache tag.

Optionally, in any of the preceding aspects the system further includes: a storage block to store a list of data evicted from the cache memory, and the rank indicators of the list of the data.

Optionally, in any of the preceding aspects the system further includes: a prefetch unit to prefetch data into the cache memory according to the rank indicators of the list of data in the storage block.

Optionally, in any of the preceding aspects the system further includes: the cache controller is configured to implement separate eviction policies according to the rank indicators.

Optionally, in any of the preceding aspects the system further includes: a control bits decoder to decode the rank indicator.

According to one aspect of the present disclosure, there is provided a non-transitory computer-readable medium storing computer instructions for cache-aware accessing of a memory system, that when executed by one or more processors, cause the one or more processors to perform the steps of: send a plurality of commands to the memory system; and send a rank indicator with each of the command of the plurality of commands, wherein each rank indicator indicates read or write rank of data accessed by the command and to be cached by a cache memory module.

Optionally, in any of the preceding aspects, another implementation of the aspect provides that the computer instructions are generated by a compiler and the rank indicator is associated with each of the plurality of commands by the compiler according to memory access patterns in the computer instructions.

Optionally, in any of the preceding aspects, another implementation of the aspect provides that the computer instructions, when executed by the one or more processors, further cause the one or more processors to modify a rank indicator associated with the data upon modification of the memory access patterns.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 illustrates an example of a multi-core system with cache memory.

FIG. 2 illustrates an example of a cache memory module.

FIGS. 3A-3C illustrate examples of aspects of a cache memory module.

FIG. 4 illustrates an example of handling read or write commands.

FIG. 5 illustrates an example of handling read or write commands.

FIG. 6 illustrates an example of a write cache hit.

FIG. 7 illustrates an example of a write cache miss.

FIG. 8 illustrates an example of a read cache hit.

FIG. 9 illustrates an example of a read cache miss.

FIG. 10 illustrates an example of cache eviction.

FIG. 11 illustrates an example of victim list management.

FIG. 12 illustrates an example of generation and use of rank indicators.

FIG. 13 illustrates examples of hardware using rank indicators.

### DETAILED DESCRIPTION

Cache replacement policies that use rank indicators to apply smart cache replacement are provided. Access rankings may be sent to a cache memory with memory access commands. When a processor sends a memory access command, the command may be sent with a rank indicator that is associated with the data referenced by the command. The rank indicator may be stored when the referenced data is cached and may subsequently be used to determine whether the data should be retained in cache, or should be replaced (evicted from cache). Thus, for example, a read command may request data with an address X and may assign a rank indicator B to data X. In response, a cache memory module may return the data with address X, cache a copy of the data in cache memory, and store rank indicator B associated with the data, for example in a cache TAG. Subsequently, when making a determination as to which data in the cache memory should be replaced, the rank indicators may be used to determine which data should be retained and which should be replaced. (For example, data with rank indicator B may be retained over data with rank indicator C, but may be removed in favor of data with rank indicator A.) In this way, the program that issues the access commands informs the cache memory module of the rankings of the data being accessed. Using such information from a program accessing the memory system may have advantages over simply looking at recent usage when identifying data to remove from cache. For example, the program issuing the commands may provide rankings that more accurately reflect subsequent access to the data than may be obtained using LRU or MRU schemes.

In some cases, a processor (e.g. a processor running a software program that access data in a main memory) may issue access rankings that are based on knowledge of subsequent access to the data by the program. For example, a particular portion of code may be used repeatedly in a routine. Early in the routine, the portion of code may be assigned a high access ranking to indicate the desirability of keeping the portion of code in cache so that it is available in cache when it is subsequently accessed. At the end of the routine, if the portion of code is not needed in a subsequent routine, the portion of code may be assigned a low ranking so that it is not retained in cache unnecessarily. Such rankings may be directly based on upcoming memory access commands generated by the program. This is in contrast to other systems that estimate future access based on prior access or other factors (e.g. LRU or MRU). Because these rank indicators are generated by the same program that generates the read and write commands, they may accurately reflect upcoming access commands and are not just extrapolated from prior access commands. Thus, data is not unnecessarily kept in cache when it is not going to be used so that the cache space is more efficiently used. This increases the number of cache hits and reduces the number of cache misses

In an example, rank indicators are generated by a compiler that can look ahead in a program to see how particular data is accessed. Whenever the compiler sees an access command it may look for subsequent access to the same data. If there is another access to the same data within a certain window (e.g. within a certain number of access commands) then it would be advantageous to keep the data in cache and it may be assigned a high rank indicator. If there is no subsequent access within a window, then keeping the data in cache would waste valuable space in cache and the data is assigned a low rank indicator. A programmer may also provide explicit instructions to a compiler that may be used when assigning rank indicators with access commands. In some cases, a compiler may not know for certain about subsequent access commands, for example, because two different routines are possible based on user input with one routine accessing the data frequently and the other routine accessing the data infrequently or not accessing it. In such cases, an intermediate rank index may be assigned. The intermediate rank indicator may subsequently be replaced as either a high rank indicator or a low rank indicator when the routine is initiated, or when a first access occurs during the routine.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

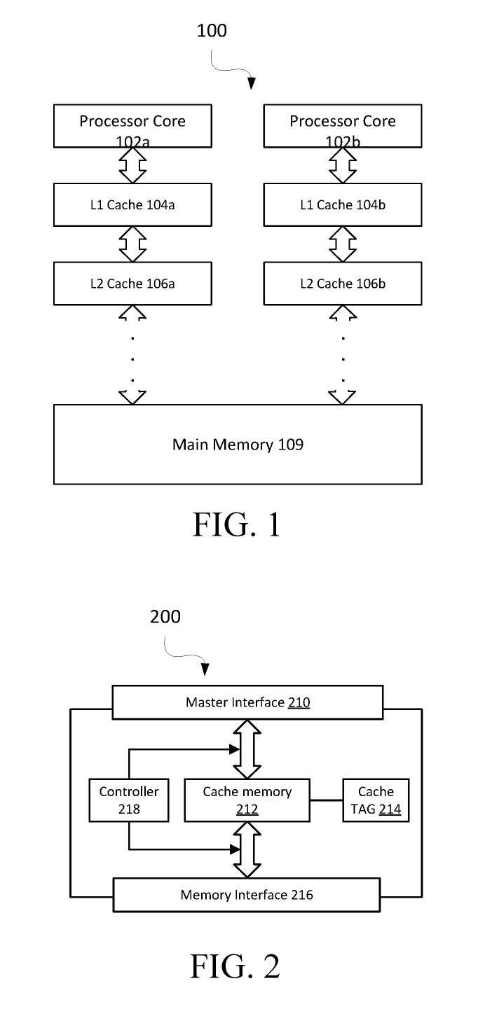

FIG. 1 shows a simplified illustration that includes multiple processor cores 102a, 102b, that access a main memory 109 in a multi-core processor system 100. Between the main memory 109 and processor cores 102a, 102b, cache memory modules provide more rapid access to cashed data than to the data in main memory. First level (L1) cache modules 104a, 104b, are located near processor cores 102a, 102b respectively. Second level (L2) cache modules 106a, 106b, are located further away from processor cores 102a, 102b. While two levels of cache memory are illustrated in FIG. 1, it will be understood that the number of such levels may vary depending on the design. One or more additional levels of cache may be located between L2 cache modules 106a, 106b, and main memory 109. In some systems, only one level of cache is provided. In a cache hierarchy, a number of levels of cache memory are arranged between a main memory and one or more processor cores. Higher levels of cache memory (closer to the processor cores) may be faster and more expensive than lower levels of cache memory (closer to the main memory). Higher levels of cache may also be smaller than lower levels.

FIG. 2 shows an example of a cache memory module 200, for example, one of the cache memory modules of FIG. 1. Cache memory module 200 includes a master interface 210 that interfaces with a processor, or with a higher-level cache that is closer to the processor. For example, if cache memory module 200 is used as L1 cache 104a, master interface 210 interfaces with processor core 102a. If cache memory module 200 is used as L2 cache 106a, master interface 210 interfaces with L1 cache 104a. Master interface 210 is connected to cache memory 212, which includes memory cells that store cached data in a manner that allows the cached data to be accessed more rapidly than data stored in a main memory. For example, cache memory may be formed of Static Random Access Memory (SRAM), Dynamic Random Access Memory (DRAM), or other volatile memory. In other examples, nonvolatile memory may be used as cache memory. A cache TAG 214 is connected to cache memory 212. Cache TAG 214 stores information about data stored in cache memory 212 such as address information and in some cases flags relating to portions of data (e.g. a valid bit or dirty bit). Cache TAG 214 facilitates a determination as to whether specific data is cached in cache memory. For example, an access command may specify an address and the cache TAG 214 may be checked to see if the data with the specified address is in cache memory 212 and if so, where in cache memory 212 (e.g. which line, or block, contains the specified data). Cache memory module 200 includes memory interface 216, which interfaces with main memory or with a lower level cache memory. For example, if cache memory module 200 is used as L1 cache 104a then memory interface 216 interfaces with L2 cache 106a. If cache memory module 200 is the lowest level of cache, then it interfaces directly with main memory 109. Cache memory controller 218 generally controls operation of cache memory module 200 including the flow of data into and out of cache memory 212.

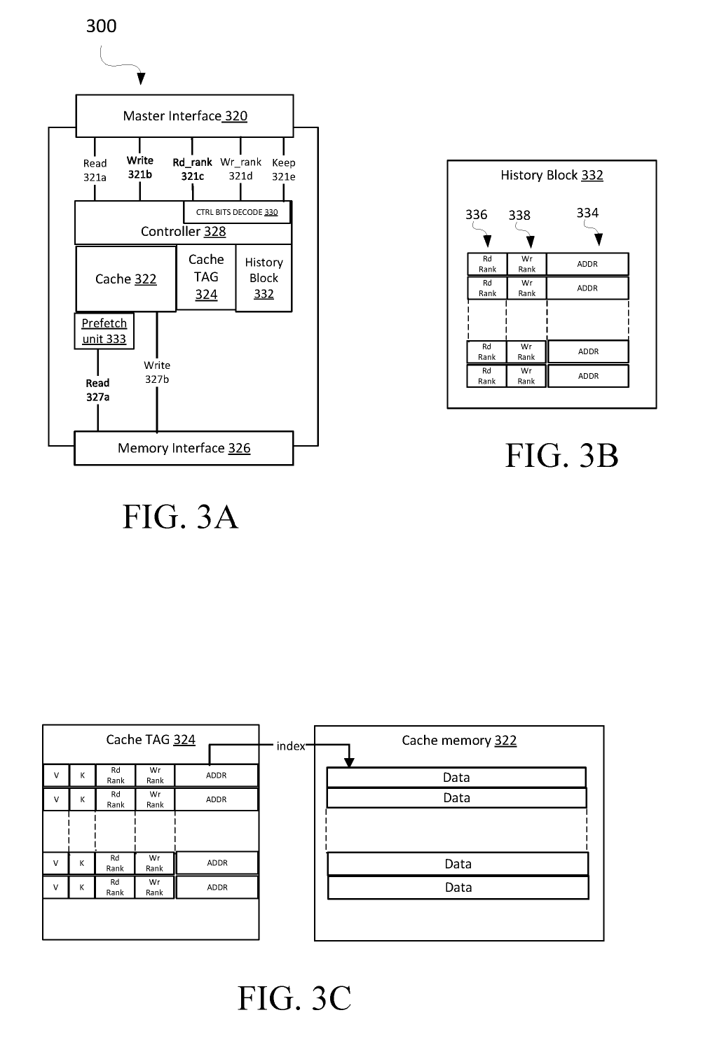

FIG. 3A shows an embodiment of a cache memory module 300. Cache memory module 300 includes a master interface 320, cache memory 322, cache TAG 324 memory interface 326, and cache controller 328. Master interface 320 may be connected to a processor or higher level cache as before. Master interface 320 is shown providing five inputs 321a-e to cache controller 328. Read input 321a and write input 321b may provide read and write commands to cache controller 328, for example, providing addresses of data to be accessed and providing data to be written in the case of write input 321b. In addition, read rank input 321c (“Rd_rank”), write rank input 321d (“Wr_rank”), and keep flag input 321e (“Keep”) provide additional information to cache controller 328 regarding the data being accessed by read and write commands respectively. Read rank input 321c provides a read rank indicator to cache controller 328, which may be saved in cache TAG 324 and may subsequently be used when determining whether corresponding data should be removed from cache memory 322. Similarly, write rank input 321d provides a write rank indicator to cache controller 328, which may be stored in cache TAG 324 and may subsequently be used when determining whether corresponding data should be removed from cache memory 322. Keep flag input 321e provides a flag to cache controller 328, which may be stored in cache TAG 324 and may be used when determining whether corresponding data should be cached or not. A control bit decoder 330 is provided to decode read rank indicators received via read rank input 321c and to decode write rank indicators received via write rank input 321d. Control bit decoder 330 may be formed as a separate circuit or may be integral with cache controller 328 as shown. Read rank input 321c and write rank input 321d may be provided as dedicated physical connections (e.g. dedicated pins in a physical interface) or may be implemented through a protocol that designates certain bits that are received over a common physical interface as rank indicators. Rank indicators may be received in parallel with corresponding commands or may be integrated with the commands so that they are received in series with other command data.

While particular structures are shown in FIG. 3A, it will be understood that alternative structures may be used to perform similar functions and that a variety of different hardware modules may be used to perform a given function. For example, master interface 320 may be considered as an example of a module for receiving read or write commands including, for a given command, at least an address and a rank indicator associated with the address. Cache controller 328 may be considered as an example of a module for reading or writing data referenced by an address, caching the data in cache memory, and storing the rank indicator. And cache controller 328 may also be considered as a module for subsequently determining whether to retain the first data in the cache memory according to the rank indicator. Multiple commands may be received and acted on by these modules, or similar modules.

In contrast to master interface 320, memory interface 326 has read input 327a and write input 327b but does not have read or write rank inputs. Read rank indicators and write rank indicators are used by a memory module and are not generally provided to main memory. They may be considered as additional instructions that are sent with a read or write command that inform a cache memory module as to how it should treat the data being accessed by the command. Such instructions are directed to the cache memory module and may be acted on by the cache memory module and so are not generally forwarded to any other component. In some examples, where multiple levels of cache are provided, rank indicators may be passed down through a cache hierarchy so that they can be used at different levels. A cache memory module may implement an efficient caching policy using rank indicators to determine which data should be removed from cache and which data should be retained in cache. Details of such cache policies are described further below.

Cache memory module 300 includes History Block 332, which may be formed of a separate physical memory, or the same physical memory as cache memory 322 and cache TAG 324. History block 332 stores addresses of data that would be desirable to have in cache but are not currently cached (e.g. because of space constraints). For example, data that was evicted because of space constraints (a “victim” of eviction) may have its address stored in a victim list in a history block or other storage. History block 332 also stores rank indicators for the addressed data. History block 332 may be read to identify addresses of data to prefetch when space becomes available in cache memory 322. In particular, the rank indicators stored in history block 332 may be used to determine which data to prefetch and in what order to prefetch it. A prefetch unit 333 is provided to prefetch data from main memory and load it into cache memory 322. For example, prefetch unit 333 may operate (alone or with cache controller 328) a prefetch routine that identifies when space is available in cache memory 322 and, when there is space available, prefetches data from main memory according to data stored in history block 332.

FIG. 3B shows an example of how history block 332 may be configured. Each line in the example of FIG. 3B includes an address in address column 334 that corresponds to data that was removed from cache memory 322. In addition, each line in history block 332 contains a corresponding read rank indicator in read rank indicator column 336 (i.e. a read rank indicator corresponding to data at the address stored on the same line in history block 332). Each line in history block 332 also includes a corresponding write rank indicator in write rank indicator column 338. While two rank indicators are stored for each address in this example, it will be understood that a single rank indicator may be stored in some examples. Additional data may also be stored in a history block in some cases and the history block is not limited to storing the data illustrated in FIG. 3B.

FIG. 3C illustrates cache memory 322 and cache TAG 324 in more detail. Cache TAG 324 provides information about data stored in cache memory 322 on a line-by-line basis in this example (a line in cache TAG 324 refers to a corresponding line in cache memory 322 so that the address column in cache TAG 324 acts as an index of data stored in cache memory 322. Cache TAG 324 includes columns for read rank (“Rd Rank”) indicators and write rank (“Wr Rank”) indicators and also includes additional columns for a valid bit (“V”) and a keep flag (“K”). The valid bit identifies the data as either valid or invalid (obsolete) so that invalid data in cache is easily identified and removed. The keep flag identifies the corresponding data in cache memory 322 as data that is to be kept if the flag is set. This may be considered a form of rank indicator but is separate from read and rank indicators in this example and overrides rank indicators (i.e. if a keep flag is asserted then rank indicators may be ignored). It will be understood that rank indicators may be provided in various ways and the technology presented here is not limited to a particular scheme.

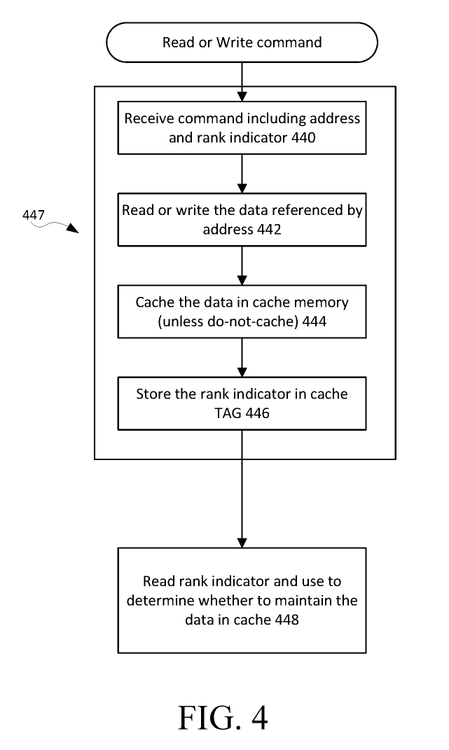

FIG. 4 illustrates an example of how rank indicators may be managed in a cache memory module. A command, such as a read command or a write command, is received 440. The command includes the address of data that is being accessed (i.e. command says what data to read or write). A rank indicator is also provided. The rank indicator may be a read rank indicator, write rank indicator, keep flag, or some combination of these rank indicators and/or other rank indicators. The data referenced by the command (i.e. data with the address specified in the command) is then read or written 442. In the example illustrated, the data is also cached 444 at this point. It will be understood that different caching policies may not cache all data that is read and written in this manner. For example, only read data may be cached, or only written data. In some cases, a rank indicator may indicate that corresponding data should not be cached. Such a do-not-cache rank indicator causes data that would otherwise be cached to bypass the cache so that it does not occupy space in cache. In the example of FIG. 4, the read and/or write rank indicator is not a do-not-cache rank indicator. For data that is cached the corresponding rank indicator is stored 446 in cache TAG. This may include storing a read rank indicator, write rank indicator, keep flag, or some combination of these rank indicators and/or other rank indicators. Steps 440, 442, 444, and 446 may be performed in response to a read or write command within a time window 447 and a response may be sent to a host indicating completion of the command. Subsequently, after time window 447, the cached data remains in cache with the rank indicator and the rank indicator may subsequently be read and used to determine whether to maintain the data in cache 448. This may happen on multiple occasions over an extended period of time after completion of the original command in time window 447. For example, if particular data is highly ranked then when a decision is made as to which data to remove from cache then the particular data's rank is read each time because it remains in cache memory. Thus, a rank indicator received with a specific command may be used during execution of the command (e.g. to determine whether to cache corresponding data) and may remain useful long after the command is executed (e.g. to determine whether to maintain data in cache or remove it).

In general, any suitable ranking system may be used to indicate how a portion of data should be managed in cache. A rank indicator may be a multi-bit value so that rank indicators provides a range of different values to indicate a range of different rankings. For example, larger values may indicate that the corresponding data should be retained in cache while smaller values may indicate that the corresponding data may be removed from cache in favor of data with a higher value rank indicator. In other cases, lower values may indicate that the data should be retained while higher values indicate that the data may be removed in favor of data with lower values. The mapping of rank indicator values to rank indicators may follow any suitable scheme. It will be understood that “higher ranked” data in this disclosure refers to data that has a rank indicator indicating that it should be retained in cache when “lower ranked” data is removed from cache and does not refer to a larger valued rank indicator.

One example of a ranking scheme uses a three bit rank indicator, with an additional “keep in cache” bit. Separate read and write rank indicators may use the same ranking scheme, or may use a different scheme. An example of a three-bit rank index uses the following mapping scheme:

| Rank Indicator values | Cache controller response |
|---|---|
| 000 | Do-not-cache |
| 001-110 | Remove data in order of rank |
| | indicator value |
| 111 | Cache-if-free |

A rank indicator value 000 indicates that the data should not be cached (“Do-not-cache”) which is the lowest ranking in this scheme. Data received with such a rank indicator should bypass cache memory. For example, if a write command sends data with a rank indicator=000, then the cache controller should send the corresponding data directly to the main memory (or higher level cache) and should bypass cache memory. If a read command is received with a rank indicator=000 then the data should be read from main memory (or higher level cache) and returned to the host, or master, without caching the data.

Rank indicators value from 001 to 110 indicate relative ranking of corresponding data (e.g. low-to-high, high-to-low, or some other mapping). This allows different portions of data in cache (e.g. different lines in cache) to be compared and retained/removed according to the comparison of rank indicators.

A rank indicator value of 111 indicates that the corresponding data should be cached only if there is free space in cache memory (“cache-if-free”). This is a relatively low ranking so the data does not displace any other data from cache and such data may be removed before other data with rankings from 001 to 110.

In addition to the three bits in the rank indicator an additional bit may act as a “keep bit” to signify that the corresponding data should be kept in cache memory during any removal of data. Thus, the keep bit may be considered an additional rank indicator that trumps any three bit rank indicator.

While the above scheme is an example of a ranking scheme, it will be understood that various other schemes may be implemented, for example, with more bits (or fewer) and with different associated cache controller responses. The present disclosure is not limited to a particular number of bits or any particular ranking scheme.

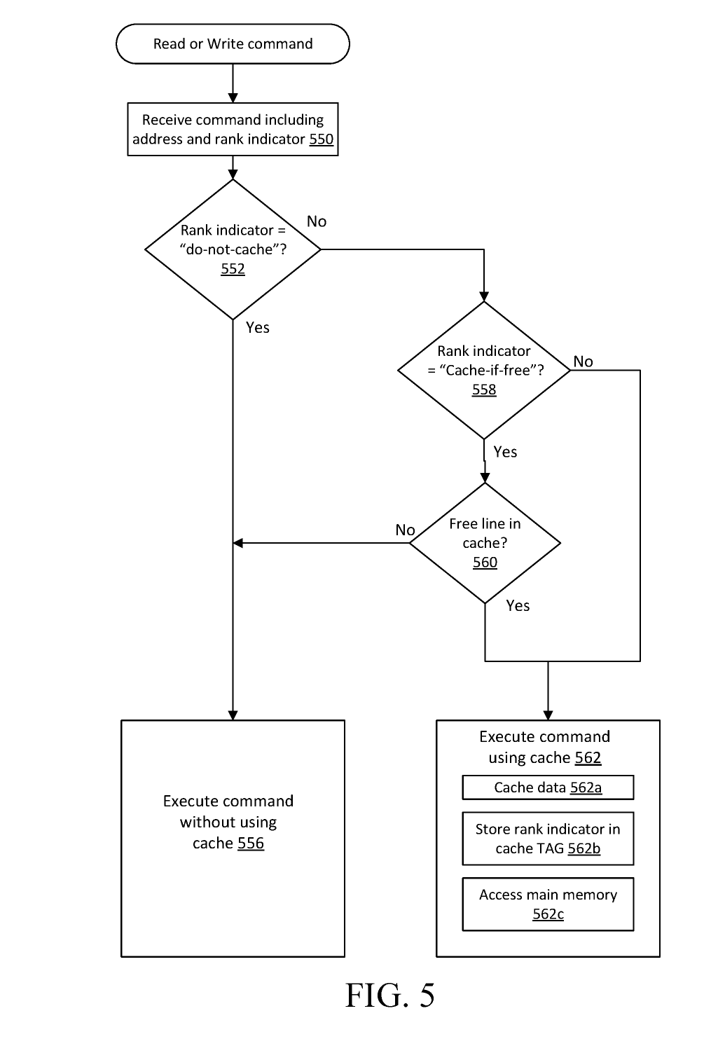

FIG. 5 shows an example of how a ranking system may be used when executing a read or write command. The read or write command, including an address and a rank indicator, is received 550. The rank indicator is decoded and a determination is made 552 as to whether the rank indicator is a do-not-cache indicator (e.g. a 000 value in the example scheme above). If the rank indicator is a do-not-cache indicator then the cache controller bypasses the cache memory and the command is executed without using cache 556 (i.e. without reading data from, or writing data to cache memory). For example, data received with a write command may be written in main memory without being cached and data read from main memory in response to a read command may be returned without being cached. In some cases, a read or write command may include a do-not-cache rank indicator along with an address of data that is present in cache. In this case, the cached copy may be valid while a copy in main memory may not be valid. For a read command, the cached copy may be returned in this case. For a write command, the cached copy becomes invalid and may be marked accordingly. Thus, cache TAG may be consulted to verify if a cached copy exists and a decision to bypass cache may be based on the result of this consultation.

If determination 552 establishes that the rank indicator is not a do-not-cache indicator then another determination 558 is made as to whether the rank indicator is a cache-if-free indicator (e.g. 111 in the example scheme above). If the rank indicator is a cache-if-free indicator then a determination 560 is made as to whether there is a free line in cache (in this example a cache line is the unit of space used, in other examples a different unit may be used). If there is no free line in cache then the cache controller bypasses cache memory and executes the command without using cache 556. On the other hand, if there is a free line in cache then the command is executed using cache memory 562. In this example, execution using cache memory includes caching data 562a (using a free line in cache if available, and evicting data to free a cache line if necessary), storing the rank indicator corresponding with the data in cache TAG 562b, and accessing main memory 562c (not necessarily in this order). If the rank indicator is not a cache-if-free indicator at step 558 then the command is similarly executed using cache memory 562.

Specific embodiments will now be described illustrating how read and write commands may be managed by a cache memory controller that uses rank indicators.

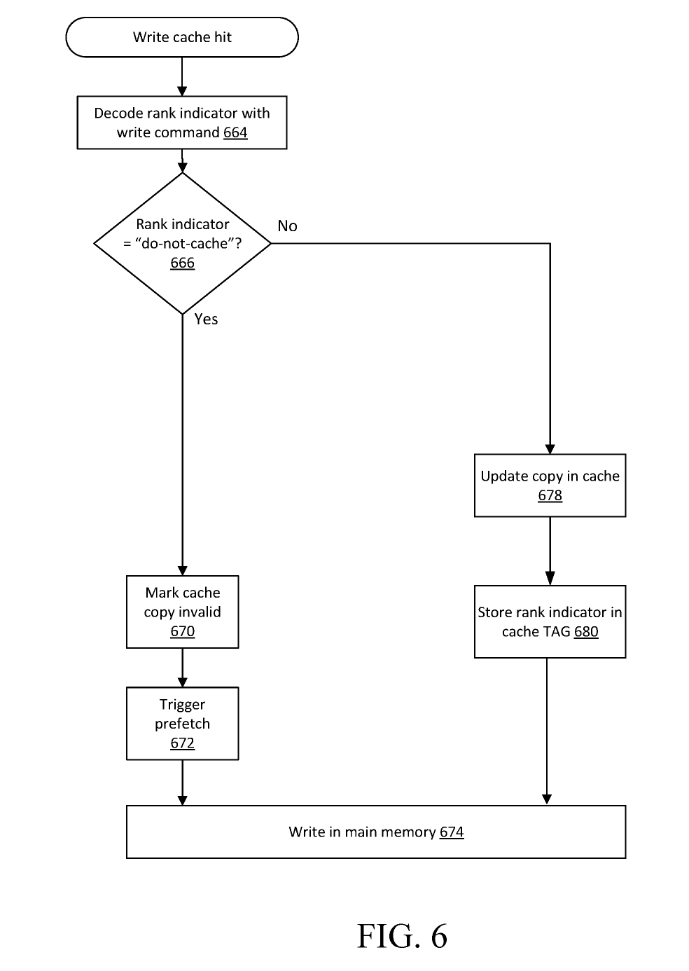

FIG. 6 illustrates an example of how rank indicators may be used when a write command results in a cache hit (i.e. the write command specifies data that is in cache memory). When the write command is received, the cache memory controller decodes the rank indicator that is received with the write command 664. Then, a determination is made 666 as to whether the rank indicator is a do-not-cache indicator. If it is a do-not-cache indicator then the memory controller bypasses cache memory and the copy of the data that is in cache memory (because this is a cache hit there is a copy in cache memory) is marked invalid 670. In some cases, marking this data as invalid may trigger a prefetch routine 672 as shown because the space occupied in cache by the invalid copy of the data is now available. The data is written in main memory 674. While triggering a prefetch 672 occurs prior to the write to main memory 674 in FIG. 6, it will be understood that a prefetch routine may be executed at some later time after writing to main memory is completed (e.g. executed as a background operation when time and resources permit). If the rank indicator is not a do-not-cache indicator at step 666 then the copy of the corresponding data in cache is updated 678. The rank indicator is stored in cache TAG 680 to indicate the rank of the corresponding data and the data is written in main memory 674.

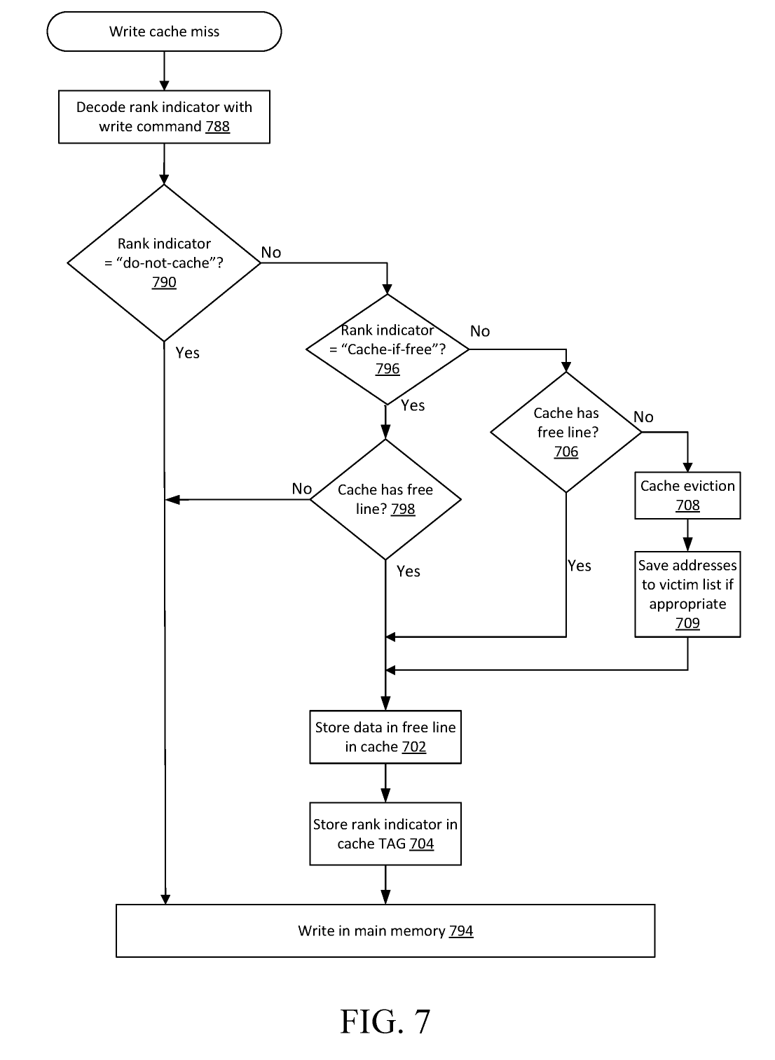

FIG. 7 illustrates an example of how rank indicators may be used when a write command results in a cache miss (i.e. the write command specifies data that is not in cache memory). When the write command is received, the cache memory controller decodes the rank indicator that is received with the write command 788. Then, a determination is made 790 as to whether the rank indicator is a do-not-cache indicator. If it is a do-not-cache indicator, then the cache memory is bypassed 792. The data is then written in main memory 794. If the rank indicator is not a do-not-cache indicator at step 790 then a further determination 796 is made as to whether the rank indicator is a cache-if-free indicator. If the rank indicator is a cache-if-free indicator, then a further determination 798 is made as to whether the cache memory has a free line where the data can be cached. If there is no free line in cache memory, then the cache is bypassed and the data is written in main memory 794. If there is a free line in cache memory at step 798 then the data is stored in the free line in cache memory 702. The rank indicator is stored in cache TAG 704 to indicate the rank of the corresponding data and the data is written in main memory 794. If the rank indicator is not a cache-if-free indicator at step 796 then a determination 706 is made as to whether there is a free line in cache memory. If there is a free line, then the data is stored in the free line in cache memory 702, the rank indicator corresponding to the data is stored in cache TAG, and the data is written in main memory 794. If there is no free line in cache at step 706 then cache eviction 708 removes data from cache to free one or more lines. Evicted data (e.g. one or more evicted lines of cache) is evaluated at this point to determine if it is a candidate for listing in a victim list. An address, or addresses are saved to a victim list if appropriate 709 based on a victim management policy. The data is then written in the free line in cache memory 702, the rank indicator corresponding to the data is stored in cache TAG 704, and the data is written in main memory 794.

While the order of steps shown in FIG. 7 provides an example, it will be understood that methods of using rank indicators may perform steps in any suitable order. For example, when it is determined that a received rank indicator is not a do-not-cache indicator (e.g. as shown at step 790) then a determination may be made as to whether cache has a free line before a determination as to whether the rank indicator is a cache-if-free indicator. If cache has a free line then data may be stored in the free line (without checking if the rank indicator is cache-if-free). If cache does not have a free line, then a determination may be made as to whether the rank indicator is a cache-if-free indicator. If the rank indicator is a cache-if-free indicator then the data is written to main memory without caching. If the rank indicator is not a cache-if-free indicator then a cache eviction may free a line in cache (and the address of evicted data may be saved to a victim list as appropriate).

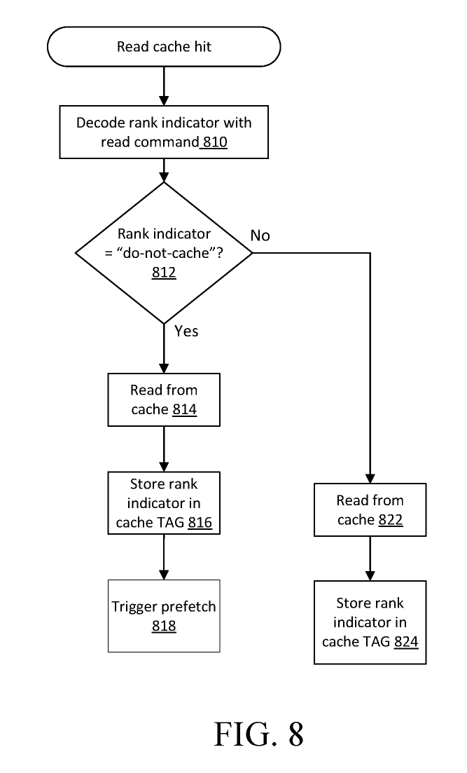

FIG. 8 illustrates an example of how rank indicators may be used when a read command results in a cache hit (i.e. the read command specifies data that is in cache memory). When the read command is received, the cache memory controller decodes the rank indicator that is received with the read command 810. Then, a determination is made 812 as to whether the rank indicator is a do-not-cache indicator. If it is a do-not-cache indicator, then the cached copy is read from cache 814 and is returned to the host. The rank indicator received with the read command is stored in cache TAG 816. While a do-not-cache indicator generally indicates that data should not be cached, in this case, data is stored in cache even though a corresponding rank indicator is a do-not-cache indicator. In this case, the data may previously have been cached with a higher rank indicator. While a subsequent access command changes its rank indicator to a do-not-cache indicator, the data may remain in cache memory. However, the do-not-cache indicator corresponding to the data generally means that it is replaced ahead of other data. In some cases, when a read cache hit occurs with a do-not-cache rank indicator, the cached copy of the data may simply be marked as invalid to make space available in cache, which may trigger a prefetch 818. It should be noted that the rank indicator that is examined at step 810 is the rank indicator received with the command, not any rank indicator stored in cache TAG. Prior to receiving this command, the data may have had a corresponding rank indicator that was not a do-not-cache indicator. If the rank indicator is not a do-not-cache indicator at step 812 then the copy of the corresponding data in cache is read from cache 822. The rank indicator that was received with the command is stored in cache TAG 824.

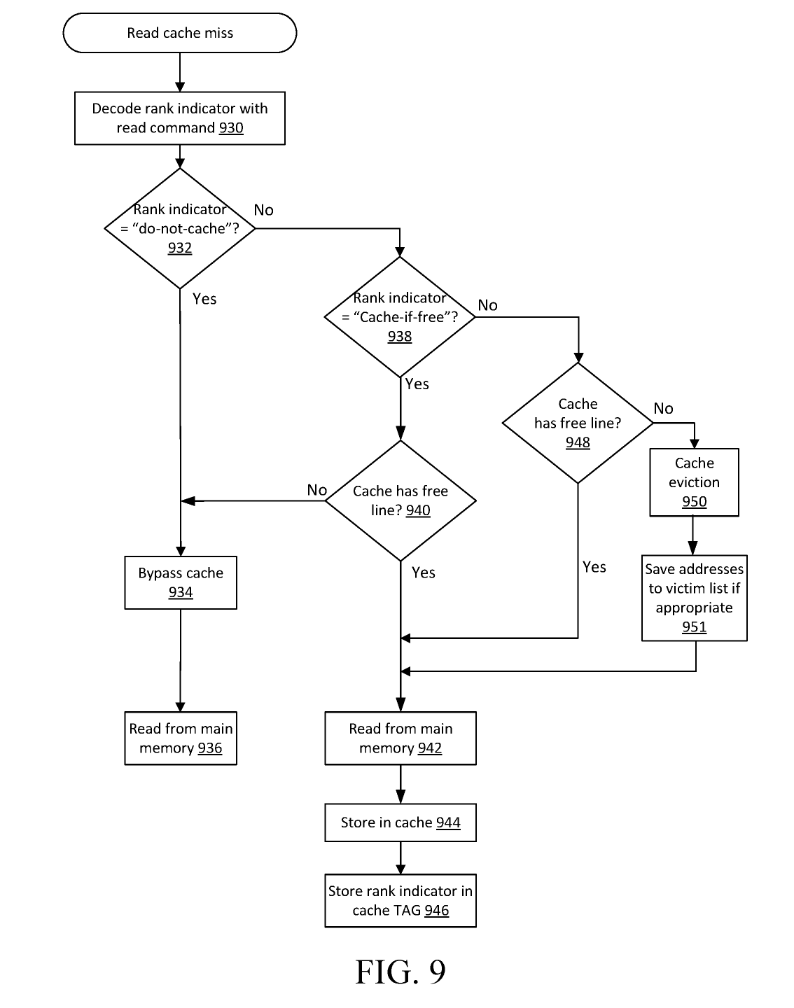

FIG. 9 illustrates an example of how rank indicators may be used when a read command results in a cache miss (i.e. the read command specifies data that is not in cache memory). When the read command is received, the cache memory controller decodes the rank indicator that is received with the read command 930. Then, a determination is made 932 as to whether the rank indicator is a do-not-cache indicator. If it is a do-not-cache indicator, then the cache memory is bypassed 934. The data is then written in main memory 936. If the rank indicator is not a do-not-cache indicator at step 932 then a further determination 938 is made as to whether the rank indicator is a cache-if-free indicator. If the rank indicator is a cache-if-free indicator, then a further determination 940 is made as to whether the cache memory has a free line where the data can be cached. If there is no free line in cache memory, then the cache is bypassed 934 and the data is written in main memory 936. If there is a free line in cache memory at step 940 then the data is read from main memory 942, stored in a free line in cache memory 944, and the rank indicator is stored in cache TAG 946. If the rank indicator is not a cache-if-free indicator at step 938 then a determination 948 is made as to whether there is a free line in cache memory. If there is a free line, then the data is read from main memory 942, stored in a free line in cache memory 944, and the corresponding rank indicator is stored in cache TAG 946. If there is no free line in cache at step 948 then cache eviction 950 removes data from cache to free one or more lines. Evicted data (e.g. one or more evicted lines of cache) is evaluated at this point to determine if it is a candidate for listing in a victim list. An address, or addresses are saved to a victim list if appropriate 951 based on a victim management policy. The data is then read from main memory 942, stored in a free line in cache memory 944, and the rank indicator corresponding to the data is stored in cache TAG 946.

While the order of steps shown in FIG. 9 provides an example, it will be understood that methods of using rank indicators may perform steps in any suitable order. For example, when it is determined that a received rank indicator is not a do-not-cache indicator (e.g. as shown at step 932) then a determination may be made as to whether cache has a free line before a determination as to whether the rank indicator is a cache-if-free indicator. If cache has a free line then read from main memory and stored in cache (without checking if the rank indicator is a cache-if-free indicator). If cache does not have a free line, then a determination may be made as to whether the rank indicator is a cache-if-free indicator. If the rank indicator is a cache-if-free indicator then the data is read from main memory without caching. If the rank indicator is not a cache-if-free indicator then a cache eviction may free a line in cache (and the address of evicted data may be saved to a victim list as appropriate).

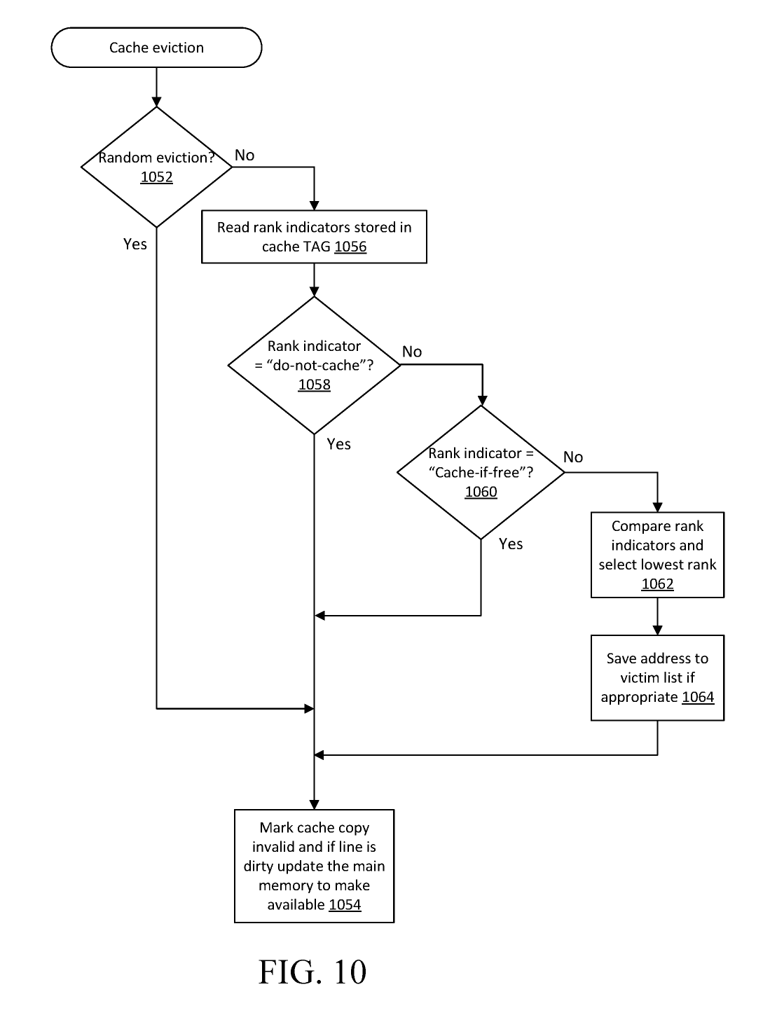

FIG. 10 illustrates an example of how rank indicators may be used in a cache eviction process that removes data from cache. An eviction process may be triggered by various events. For example, when there is data to be cached and there is no free space in cache eviction may be triggered in order to open up some space in cache memory to enable caching. Eviction may also be triggered in response to determining that data currently in cache has a low likelihood of being used in the future (e.g. relatively low rank indicators). An eviction process may be triggered by a specific command from a cache-aware host in order to ensure that there is sufficient space in cache for subsequent caching. FIG. 10 shows an initial determination 1052 as to whether a random eviction is to be performed. Random eviction, as the name suggests, is an eviction that is performed in a random fashion to ensure that data that is not evicted by any other part of an eviction scheme eventually gets evicted and so does not occupy a portion of cache indefinitely (i.e. does not become a “dead” line in cache memory). Random evictions may be performed at random times and/or on random locations in cache memory. In one example, a wrap-around counter progresses line-by-line through cache memory at some random intervals so that each line of cache eventually gets randomly evicted. If a random eviction is called for then the portion of cache memory identified for eviction (e.g. line of cache) may be marked as invalid to make space available 1054 (an invalid line in cache is available for caching new data). If random eviction is not triggered, then the rank indicators stored in cache TAG are read 1056. All, or some rank indicators may be read and acted on in any suitable order. For example, a first iteration of the scheme of FIG. 10 may act on lower order rank indicators and a subsequent iteration may act on higher order rank indicators. Multiple iterations may be performed in ascending order and the results may be evaluated to determine which cached data to evict. A determination is then made 1058 as to whether any of the rank indicators are do-not-cache indicators. If there are any do-not-cache rank indicators in cache TAG, then the corresponding data is marked as invalid to make space available 1054. If there are no do-not-cache indicators at step 1058 then another determination 1060 is made as to whether any rank indicators are cache-if-free indicators. If there are any cache-if-free indicators, then the corresponding data in cache memory is marked invalid to make space available 1054. If no cache-if-free indicators are found in step 1060 then rank indicators from cache TAG are compared and the lowest rank indicators are selected 1062. In a given scheme, read rank indicators alone may be used, write rank indicators alone may be used, or a combination of read rank indicators may be used. For example, read caching may be prioritized over write caching by weighting read rank indicators and write rank indicators when comparing rank indicators for different data. In a multi-thread environment, where one or more processors send(s) commands associated with different threads, threads may be prioritized by weighting rank indicators associated with commands for different threads differently.

In some cases, data that is evicted and has a sufficiently high rank index may be returned to cache memory at a later time when space in cache memory is available. To facilitate this process, addresses of evicted data may be saved to a victim list as appropriate 1064. (While earlier examples showed cache eviction and saving addresses to a victim list separately, the example of FIG. 9 includes both cache eviction 950 and saving addresses to victim list if appropriate 951 as steps within a cache eviction process. A victim list may also include addresses of uncached data that was not evicted from cache, which may be worth prefetching into cache, e.g. data having a do-not-cache or cache-if-free rank indicator. For example, all evicted data, or all evicted data having a rank indicator above a threshold may have its address and rank indicator saved to a victim list that is stored in a history block in a cache memory module. Victim list entries may be based on applications and can be programmed. For example, selection of evicted data to be listed in a victim list may be based on hints from a processor, a cache controller, or other component. The decision to maintain a particular address in a victim list may be decided based on some programmed values. It will be understood that entries in a victim list may refer to data using any suitable indicator including a logical address, physical address, file and/or offset, or another indicator or indicators. The cache copy is marked invalid if the corresponding line is dirty and the main memory is updated to make space available 1054.

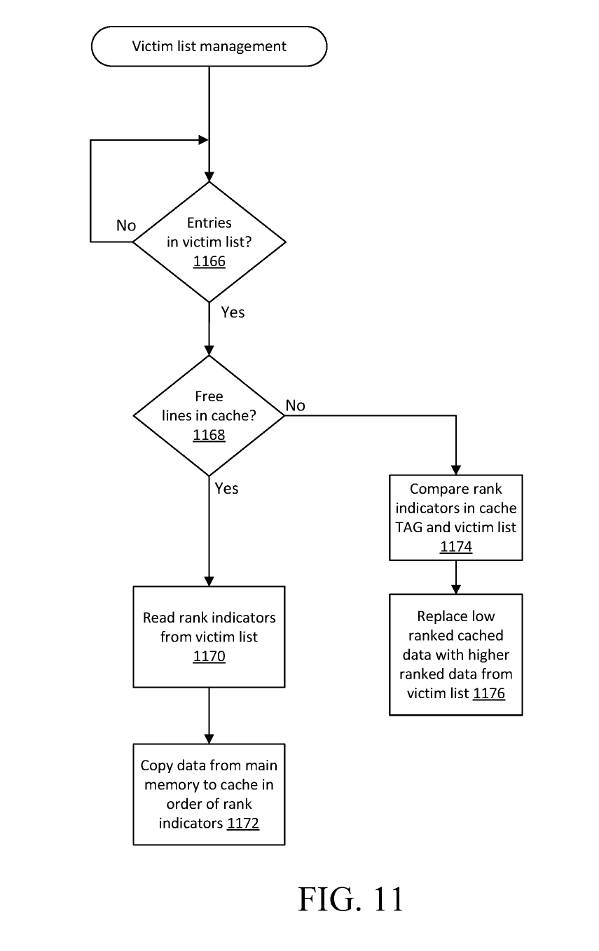

FIG. 11 illustrates operation of a victim list, which may be stored in a history block in a cache memory module, or in another suitable location, in some ordering such as a rank-order, First-In First-Out (FIFO), Last-In Last-Out (LIFO), or other order. The scheme shown in FIG. 11 may be run continuously, periodically, or may be triggered by certain events, and may be considered a prefetch routine. A determination is made 1166 as to whether there are any entries in a victim list. As long as there are no entries, the process loops back so that it continues to look for entries. In other examples, no such loop may be used and a prefetch routine may terminate if there are no entries in a victim list. If an entry is found in the victim list, then a determination is made 1168 as to whether there are any free lines in cache. If there are any free lines in cache, then rank indicators are read from the victim list 1170. Data is then copied from main memory to free space in cache in order of corresponding rank indicators 1172. In this way, data that was evicted from cache memory because of shortage of space is returned to cache memory when space allows. Rank indicators facilitate identification of data to be returned in this way since not all evicted data is worth returning to cache. If there are no free lines in cache memory at step 1168, then rank indicators in cache TAG may be compared with rank indicators in the victim list 1174. In this example, cached data, such as low ranked cached data may be replaced with higher ranked data from the victim list 1176. In some examples, data with relatively few subsequent accesses may be retained in cache, while data with a larger number of subsequent accesses may be removed, on the basis that the former is “almost done” and may be retained until it is “finished,” i.e. if the cost of prefetching is prorated against the number of subsequent accesses then it may be better to evict data with a larger number of subsequent accesses. In other cases, data identified from the victim list may only be returned to cache memory when there is free space in cache memory.

Rank indicators may be generated in various ways and may be generated by various components in a system. In an embodiment, a processor that issues read and write commands also generates rank indicators that it sends with the commands. In some cases, rank indicators may also be updated separately from commands. A processor that runs software and issues read and write commands may not have knowledge of the memory system or of any cache memory used in the memory system. Awareness of the presence and nature of cache memory may allow a processor to more efficiently access data stored by the memory system. For example, such a cache aware processor can include rank indicators to inform the memory system which data to maintain in cache. In turn, a memory system that acts on such information from a processor is better able to identify data to retain and remove from cache than a memory system that does not receive any such information and operates based on recent access by the processor (e.g. LRU or MRU).

A processor may be configured to send read and write commands by a software program that runs on the processor. Where a portion of program code includes an access command to a memory system, and it is expected that a cache memory will be present in the memory system, additional information may be conveyed in the form of rank indicators so that the memory system can cache data efficiently. In general, program code that runs on a processor is compiled code (i.e. it is code generated by compiling source code). In an embodiment, rank indicators may be generated by a compiler so that they are added to a program at compile time. Thus, rank indicators may be found in compiled code where no rank indicators may be found in the corresponding source code. In some cases, a programmer may provide information in source code that may help a compiler to assign rank indicators, or may explicitly call for certain rank indicators. For example, particular data may be marked as “do-not-cache” or “keep” by a programmer because of how the program uses the data.

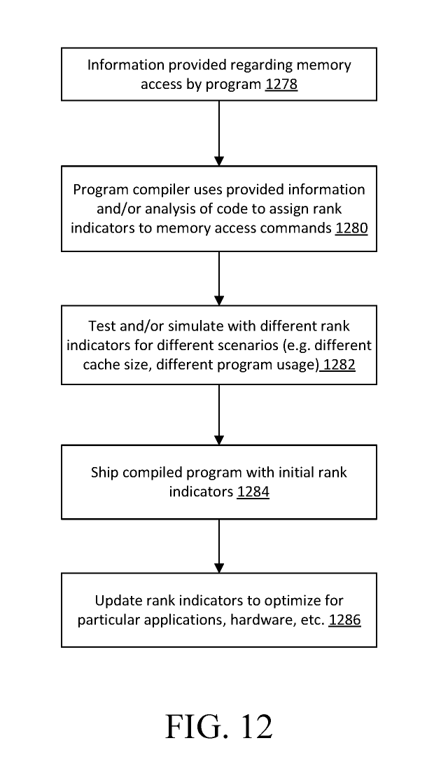

FIG. 12 illustrates an example of how cache aware software may be generated and used including generating and using rank indicators. Information regarding memory access by a program is provided 1278. For example, in a directive pragma in C programming language (#pragma), information for the compiler to specify how portions of code are to be compiled includes how to prioritize data for caching. In some cases, the compiler does not receive any information about cache usage. The program compiler then uses this information and/or analysis of the program code to assign rank indicators to memory access commands 1280. In general, a compiler can compute reuse distance of cache lines by reviewing the program code and assign rank indicators accordingly. For example, a compiler may see that the same portion of data is used multiple times in a routine and assign a high rank indicator, while another portion of data may be used infrequently and may be assigned a low rank indicator. Test and/or simulation with different rank indicators for different scenarios (e.g. different cache size, different program usage) is performed 1282. A compiler may pre-simulate cache behavior to determine which rank indicators to use. For example, a compiler may pre-simulate for given cache dimensions. In some cases, a compiler may also access a repository of rank indicator information associated with some code patterns. For example, portions of code (that may be open source or otherwise available to a compiler) may have publicly available sets of rank indicators associated with them and these sets of rank indicators may be generated by data mining across multiple examples by different users. A compiled program with initial rank indicators is then shipped 1284. For example, an application may be made available for download with an initial set of rank indicators assigned by a compiler. Subsequently, rank indicators are updated to optimize for particular applications, for particular hardware, etc. 1286. In some cases, software updates may update rank indicators. In some cases, programs may optimize their own rank indicators without outside input.

While some examples above are directed to a processor that sends information directed to caching and to a cache memory module that is adapted to receive and act on such information, it will be understood that a processor may send information directed to caching even if a cache memory module does not act on it, and that a cache memory module adapted to receive and act on such information will operate even without such information. That is to say, backward compatibility may be maintained by adding rank indicators in such a way that they are not received by, or are not acted on, by memory systems that are not adapted to receive and act on them. A conventional memory system may receive rank indicators and simply ignore them. And a cache memory module that is adapted to receive and act on rank indicators may simply act as a conventional cache memory module if it does not receive rank indicators (e.g. it may implement some conventional cache replacement scheme).

In some examples above, particular hardware is described. Hardware other than that of the examples described here may also be used. It will be understood that memory systems that include cache memory are widely used in a variety of applications and that many processors are configured to read data from memory and write data to memory. Cache memory may be local to a processor (physically close to a processor) or may be remote and embodiments described above are not limited to particular physical arrangements.

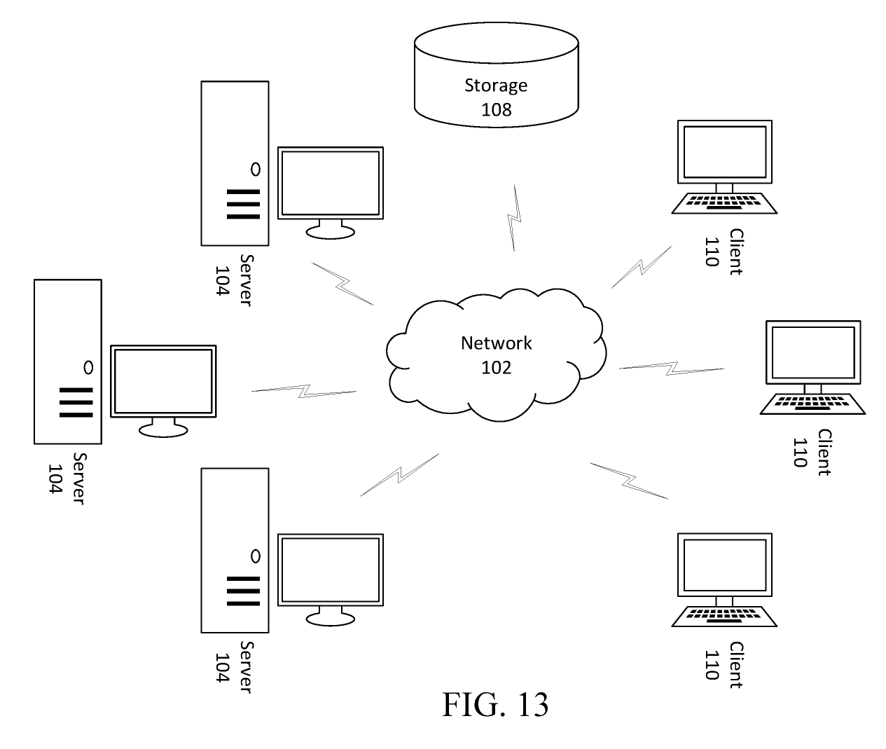

FIG. 13 illustrates a computing environment in which rank indicators may be used in various locations. For example, clients 110 may be PCs or other devices that include one or more processors, cache memory (one or more levels), and main memory. A program operating on client 110 may issue read and write commands with rank indicators and a cache memory module in client 110 may operate a cache replacement policy based on the rank indicators it receives. Similarly, a server 104 may include one or more processors, cache memory (one or more levels), and main memory. A program operating on server 104 may issue read and write commands with rank indicators and a cache memory module in server 104 may operate a cache replacement policy based on the rank indicators it receives. In other examples, a cache memory and a processor interacting with the cache memory may be at different locations and may be connected through a network. For example, a program operating on client 110 may access data in a memory system in server 104 through network 102. The program may issue read and write commands with rank indicators that may be used by a local cache memory module in client 110 and/or a cache memory module in server 104 (i.e. either local caching, remote caching, or both may use rank indicators). Similarly, a processor in server 104 or client 110 may access storage 108 through network 102 using rank indicators. A cache memory module in client 110 and/or server 104 and/or storage 108 may implement a cache replacement policy according to the rank indicators received.

The technology described herein can be implemented using hardware, software, or a combination of both hardware and software. The software used is stored on one or more of the processor readable storage devices described above to program one or more of the processors to perform the functions described herein. The processor readable storage devices can include computer readable media such as volatile and non-volatile media, removable and non-removable media. By way of example, and not limitation, computer readable media may comprise computer readable storage media and communication media. Computer readable storage media is non-transitory and may be implemented in any method or technology for storage of information such as computer readable instructions, data structures, program modules or other data. Examples of computer readable storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as RF and other wireless media. Combinations of any of the above are also included within the scope of computer readable media.

In alternative embodiments, some or all of the software can be replaced by dedicated hardware including custom integrated circuits, gate arrays, FPGAs, PLDs, and special purpose computers. In one embodiment, software (stored on a storage device) implementing one or more embodiments is used to program one or more processors. The one or more processors can be in communication with one or more computer readable media/storage devices, peripherals and/or communication interfaces. In alternative embodiments, some or all of the software can be replaced by dedicated hardware including custom integrated circuits, gate arrays, FPGAs, PLDs, and special purpose computers.

The disclosure has been described in conjunction with various embodiments. However, other variations and modifications to the disclosed embodiments can be understood and effected from a study of the drawings, the disclosure, and the appended claims, and such variations and modifications are to be interpreted as being encompassed by the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate, preclude or suggest that a combination of these measures cannot be used to advantage. A computer program may be stored or distributed on a suitable medium, such as an optical storage medium or a solid-state medium supplied together with, or as part of, other hardware, but may also be distributed in other forms, such as via the Internet or other wired or wireless telecommunication systems.

The foregoing detailed description has been presented for purposes of illustration and description. It is not intended to be exhaustive or to limit the subject matter claimed herein to the precise form(s) disclosed. Many modifications and variations are possible in light of the above teachings. The described embodiments were chosen in order to best explain the principles of the disclosed technology and its practical application to thereby enable others skilled in the art to best utilize the technology in various embodiments and with various modifications as are suited to the particular use contemplated. It is intended that the scope of the present application be defined by the claims appended hereto.

What is claimed is:

1. A method of operating a cache memory, comprising:
receiving a first read or write command including at least a first address referring to first data and a first rank indicator associated with the first data; and
in response to receiving the first read or write command, reading or writing the first data referenced by the first address, and
storing the first rank indicator.

2. The method of claim 1 further comprising:
caching the first data in the cache memory; and
determining whether to retain the first data in the cache memory according to the first rank indicator.

3. The method of claim 1, wherein the first rank indicator is a do-not-cache indicator, further comprising:
in response to receiving the first read or write command, reading or writing the first data referenced by the first address without caching the first data in the cache memory.

4. The method of claim 1, further comprising:
receiving a second read or write command including at least a second address and a second rank indicator associated with the second address;
in response to receiving the second read or write command, reading or writing second data referenced by the second address, caching the second data in the cache memory, and storing the second rank indicator; and
determining whether to retain the first or second data in the cache memory by comparing the first rank indicator and the second rank indicator.

5. The method of claim 1, wherein the first rank indicator is at least one of a read rank indicator, a write rank indicator, a keep indicator, a valid indicator, a do-not-cache indicator, or a cache-if-free indicator.

6. The method of claim 1, wherein the first rank indicator is a multi-bit value that is sent with a corresponding read or write command.

7. The method of claim 1 further comprising:
receiving an updated rank indicator associated with the first address, the updated rank indicator being different from the first rank indicator;
replacing the first rank indicator with the updated rank indicator; and
determining whether to retain the first data in the cache memory according to the updated rank indicator.

8. The method of claim 1 further comprising:
retaining a list of rank indicators for data that was evicted from the cache memory; and
identifying evicted data to be prefetched into the cache memory according to rank indicators in the list of rank indicators.

9. The method of claim 8, further comprising:
prefetching evicted data with rank indicators higher than a threshold into the cache memory.

10. The method of claim 8, further comprising:
comparing rank indicators of evicted data; and
prefetching data into the cache memory in descending order from higher rank to lower rank.

11. A system comprising:
a cache memory, wherein the cache memory comprises:
a master interface to receive a command and a rank indicator;
a cache tag to store the rank indicator, wherein the rank indicator in the cache tag referring to data accessed by the command and indicating read or write rank of the data; and
a memory interface to read or write data to a memory of the system.

12. The system of claim 11 wherein the rank indicator comprises at least one of a read rank indicator, a write rank indicator, a keep indicator, a valid indicator, a do-not-cache indication, or a cache-if-free indicator.

13. The system of claim 11 further comprising a cache controller to evict data from the cache memory according to the rank indicator in the cache tag.

14. The system of claim 13 further comprising a storage block to store a list of data evicted from the cache memory, and the rank indicators of the list of the data.

15. The system of claim 14 further comprising a prefetch unit to prefetch data into the cache memory according to the rank indicators of the list of data in the storage block.

16. The system of claim 13 wherein the cache controller is configured to implement separate eviction policies according to the rank indicators.

17. The system of claim 11 further comprising a control bits decoder to decode the rank indicator.

18. A non-transitory computer-readable medium storing computer instructions for cache-aware accessing of a memory system, that when executed by one or more processors, cause the one or more processors to perform the steps of:
send a plurality of commands to the memory system; and
send a rank indicator with each of the command of the plurality of commands, wherein each rank indicator indicates read or write rank of data accessed by the command and to be cached by a cache memory module.

19. The non-transitory computer-readable medium of claim 18 wherein the computer instructions are generated by a compiler and the rank indicator is associated with each of the plurality of commands by the compiler according to memory access patterns in the computer instructions.

20. The non-transitory computer-readable medium of claim 19 wherein the computer instructions, when executed by the one or more processors, further cause the one or more processors to modify a rank indicator associated with the data upon modification of the memory access patterns.
